(19) United States
(12) Patent Application Publication
(10) Pub. No.: US 2006/0104321 A1
(43) Pub. Date: May 18, 2006

(54) Q-MODULATED SEMICONDUCTOR LASER WITH ELECTRO-ABSORPTIVE GRATING STRUCTURES

(75) Inventor: Jian-Jun He, Ottawa (CA)

Correspondence Address: LIGHTIP TECHNOLOGIES, INC., 40 COLLEGE CIRCLE, OTTAWA, ON, K1K-4R8, CA

(73) Assignee: LIGHTIP TECHNOLOGIES INC., Ottawa (CA)

(21) Appl. No.: 11/163,019

(22) Filed: Oct. 3, 2005

Related U.S. Application Data
(60) Provisional application No. 60/628,296, filed on Nov. 15, 2004.

(51) Int. Cl. H01S 3/10

(52) U.S. Cl. 372/26

(57) ABSTRACT

A Q-modulated semiconductor laser comprises a λ/4-phase-shifted distributed-feedback grating. Two isolated electrodes are deposited on top of the grating, and one electrode is deposited on the back side of the laser substrate as a common ground. The first top-side electrode covers a portion of the grating including the phase-shift region, and provides an optical gain for the laser when a constant current is injected. The second top-side electrode covers the remaining portion of the grating away from the phase-shift region, which acts as a Q-modulator of the laser. An electrical signal is applied on the second electrode to change the absorption coefficient of the waveguide in the modulator section, resulting in a change in the Q-factor of the laser, and consequently the lasing threshold and output power. The integrated Q-modulated laser has advantages of high speed, high extinction ratio, low wavelength chirp and low cost.

### RELATED APPLICATIONS

This application claims benefit from U.S. Provisional Patent Application Ser. No. 60/628,296, filed on Nov. 15, 2004, entitled “Q-modulated semiconductor distributed feedback laser”.

### FIELD OF THE INVENTION

This invention relates generally to semiconductor lasers and modulators, and more particularly to a semiconductor distributed feedback (DFB) or distributed Bragg reflector (DBR) laser monolithically integrated with a Q-modulator that changes the Q-factor of the laser cavity through current injection or electro-absorption effect.

### BACKGROUND OF THE INVENTION

High-speed semiconductor lasers and modulators are essential components in today's fiber-optic communication systems. The rapid increase in internet traffic has demanded these optical components to be able to handle greater bit rates. Direct amplitude modulation by varying the bias current of the laser is the simplest method, without a need for an external modulator. However, the directly modulated laser has fundamental speed limits, and will display transient oscillation at a frequency equal to its relaxation oscillation frequency. Wavelength chirp is another problem arising in directly modulated lasers. As the input drive current of a laser changes, so does the carrier density, hence refractive index, and therefore wavelength. The laser wavelength moves in opposite directions respectively as the pulse rises and falls. The higher the bit rate, the more the chirp begins to manifest itself as an effective widening of the laser linewidth. Due to chromatic dispersion in optical fibers, pulse spreading is more severe in the case of a wider laser linewidth, thereby limiting the transmission distance.

It is possible to keep the laser in continuous wave (CW) operation, and modulate it externally. This would eliminate the aforementioned problem of transient oscillation, and reduce the chirp, provided that the modulator suffers from less severe chirp than the laser. An electroabsorption modulator (EAM) is a viable option as an external modulator. Some of its advantages compared to other alternatives are: low drive voltages, small size, and the ability to be monolithically integrated with distributed feedback (DFB) or distributed Bragg reflector (DBR) lasers. An EAM is based on a very similar structure to a laser, with an active layer of a slightly different bandgap energy. Another difference is that it is operated in reverse bias. As the input stream of data bits alters the modulator reverse bias, the absorption coefficient of the modulator changes, thus varying the transmitted optical power.

Although the EAM improves the chirp performance considerably compared to direct modulation of the laser, the chirp problem remains due to refractive index change intrinsically associated with the modulation of absorption coefficient. More importantly, the modulator chirp is dynamic and changes with the actual drive voltage. Electro-absorption modulators now provide modulation capability up to about 10 Gb/s. At the moment it is not clear that electro-absorption modulators can reach higher speed (e.g. 40 Gb/s) without introducing considerable parasitic phase modulation. Besides, the monolithic integrated electro-absorption modulated laser (EML) requires multiple epitaxial growths, and therefore complex and costly fabrication process.

Another possibility to modulate light is to use a Mach-Zehnder interferometer in a material showing strong electro-optic effect (such as LiNbO₃). By applying a voltage the optical signal in each path is phase modulated as the optical path length is altered by the electric field. Combining the two paths with different phase modulations converts the phase modulation into intensity modulation. If the phase modulation is exactly equal in each path but different in sign, the modulator is chirp free, this means the output is only intensity modulated without parasitic phase or frequency modulation. However, such an external modulator is very expensive.

It is an object of the present invention to provide a single-mode semiconductor laser monolithically integrated with a high-speed low-chirp modulator that has low cost and fabrication simplicity similar to that of a directly modulated laser.

### SUMMARY OF THE INVENTION

In accordance with the invention, there is provided, a Q-modulated semiconductor laser comprising:

a phase-shifted grating embedded in an active optical waveguide layer structure,

a first waveguide section with a first segment of the grating embedded therein, and a second waveguide section with a second segment of the grating embedded therein, said first and second segments of the grating being on opposite sides of the phase-shift region,

a third waveguide section with a third segment of the grating embedded therein, said third waveguide section being adjacent to the second waveguide section,

a first electrode deposited on top of the first and the second waveguide sections, said first electrode being used for injecting a constant current into underlying active optical waveguide to provide optical gain to the laser,

a second electrode deposited on top of the third waveguide section, said second electrode being used for providing an electrical signal to change the optical loss of underlying optical waveguide so that the change of the optical loss causes a change in the output power of the laser.

In accordance with another embodiment of the invention, there is provided, a Q-modulated semiconductor laser comprising:

a first distributed Bragg reflector grating,

a second distributed Bragg reflector grating,

a gain section placed between the first and the second distributed Bragg reflector gratings, said gain section being sandwiched between a pair of electrodes for injecting a constant current to provide optical gain to the laser,

an electrically-controllable absorption section being placed within the second distributed Bragg reflector grating, said electrically-controllable absorption section being sandwiched between a pair of electrodes for providing an electrical means to change the optical loss of said electrically-controllable absorption section so that the change of the optical loss causes a change in the output power of the laser.

### BRIEF DESCRIPTION OF THE DRAWINGS

FIG. 1 is a schematic diagram of a prior-art semiconductor laser modulated by an external modulator or an integrated electro-absorption modulator.

FIG. 2 is a generic schematic diagram of the semiconductor laser monolithically integrated with a Q-modulator of the present invention.

FIG. 3 is a schematic drawing of a Q-modulated semiconductor laser in accordance with one embodiment of the present invention.

FIG. 4 is the reflectivity spectra of the laser structure for light incident from the gain section side, when the modulator is set to the transparent (on) and absorptive (off) states.

FIG. 5 is the reflectivity spectra (a) and reflection phase change (b) of the DBR grating on the modulator side of the phase-shift when the absorption coefficient of the modulator waveguide is i) α=0; ii) α=500 cm⁻¹; and iii) α=500 cm⁻¹ accompanied with a refractive index increase of 0.005.

FIG. 6 is the transmissive small signal gain spectra of the laser structure for two different modulator states corresponding to absorption coefficient α=0, and α=500 cm⁻¹.

FIG. 7 is the laser threshold gain coefficient as a function of the modulator absorption.

FIG. 8 is the intensity distribution inside the laser structure when the modulator is in the on-state (a) and off-state (b).

FIG. 9 is the intensity distribution inside the laser structure with the phase-shift implemented as a 50 μm grating segment with a different effective index when the modulator is in the on-state (a) and off-state (b).

FIG. 10 is a schematic drawing of another embodiment of the present invention which involves DBR gratings.

FIG. 11 is a schematic drawing of another embodiment of the present invention which involves DBR gratings and an anti-resonant modulator cavity.

### DETAILED DESCRIPTION

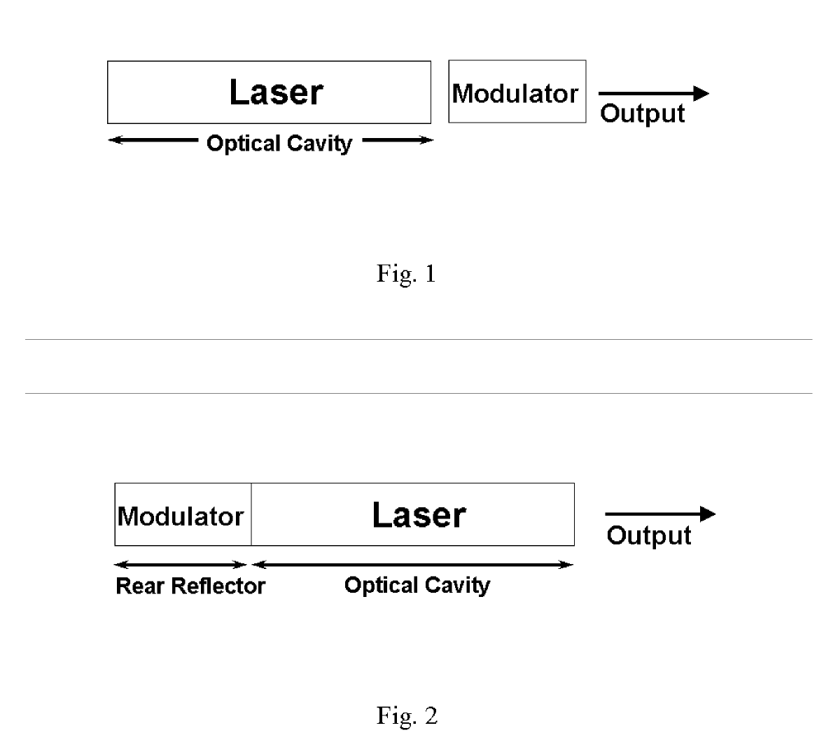

FIG. 1 is a schematic diagram of a prior-art semiconductor laser modulated by an external modulator or an integrated electro-absorption modulator. The modulator is placed in front of the laser. In the case of an electro-absorption modulator, an electrical signal is applied on the modulator to change its absorption coefficient. The output beam of the laser traverses through the modulator with a low loss when the modulator is in the on-state and is mostly absorbed when the modulator is in the off-state. In the case of a modulator based on Mach-Zehnder interferometer, the modulator is turned on and off by changing the refractive index and consequently the phase in one arm of the interferometer relative to another. An example of such devices is described in U.S. Pat. No. 4,558,449 by E. I. Gordon, issued on Dec. 10, 1985.

FIG. 2 is a generic schematic diagram of a semiconductor laser monolithically integrated with a Q-modulator, illustrating the principle of the present invention. The modulator is located in a rear reflector affecting the threshold of the laser. By varying the absorption coefficient of the modulator waveguide through a current injection or electro-absorption effect, the reflectivity of the rear reflector is changed, resulting in the modulation of the laser threshold and output power.

The Q factor or quality factor of an optical resonator of a laser is a measure of how much light from the gain medium of the laser is fed back into itself by the resonator. A high Q factor corresponds to low resonator losses per roundtrip, and vice versa. The basis of Q-modulation is the use of a device which can alter the Q factor of the resonator. This has been implemented in Q-switched dye or solid state lasers for generating short periodic pulses. The commonly used prior art methods for the Q-switching include the use of a rotating mirror, or an electro-optic or acousto-optic modulator inside the optical cavity.

For the modulation of a semiconductor laser, reducing wavelength chirp is a very important consideration. Placing a modulator inside the resonant laser cavity, as described in U.S. Pat. No. 4,667,331 by R. C. Alferness et al, issue on May 19, 1987, is not a viable method because it will introduce a large wavelength chirp similar to a directly modulated laser, in addition to fabrication complexity.

In U.S. Pat. No. 6,519,270 by H. B. Kim and J. J. Hong, issue on Feb. 11, 2003, a compound cavity laser formed by a single mode DFB laser integrated with a passive waveguide section is described. The refractive index of the passive waveguide is modulated to cause a phase modulation in the effective reflectivity of the rear cleaved facet of the passive waveguide, resulting in frequency modulation of the laser. The frequency modulated light is then converted into intensity modulated light by using an additional narrow band optical filter such as a Mach-Zehnder interferometer in the front of the laser. While the modulator is placed at the rear end of the laser, it does not change the Q-factor of the laser but only the phase, resulting in frequency modulation. The need for a narrow band filter to convert frequency modulation into intensity modulation makes it impractical to use in conventional communication systems. The required active-passive waveguide integration also makes the device fabrication difficult and costly.

In an article entitled “Q-modulation of a surface emitting laser and an integrated detuned cavity”, S. R. A. Dods, and M. Ogura, IEEE Journal of Quantum Electronics, vol. 30, pp. 1204-1211, 1994, a vertical cavity surface emitting laser with a vertically integrated detuned resonant cavity is described and analyzed. Intensity modulation of the laser is achieved by changing the refractive index inside the detuned resonant cavity. The same principle is used in U.S. Pat. No. 6,215,805 by B. Sartorius and M. Moehrle, issued on Apr. 10, 2001. In both of the above two prior arts, one of the reflectors of the laser cavity is a slightly detuned resonant cavity. Its reflectivity is highly dispersive at the operating wavelength of the laser, i.e. its reflectivity spectrum exhibits a sharp negative peak near the laser wavelength. This high reflectivity dispersion is necessary so that a small refractive index change in the slightly detuned resonant cavity can cause a large reflectivity change of the reflector, thus leading to the modulation of the laser. However, these prior art methods present significant drawbacks: 1) the reflectivity is highly wavelength dependent near resonance condition, thus requiring precise wavelength alignment with a predetermined detuning between the two resonant cavities (i.e. the modulator cavity and the main laser cavity), which is very difficult and fabrication sensitive; and 2) the reflectivity change caused by the refractive index change in the detuned modulator resonant cavity is accompanied by a large phase change, which results in a large wavelength chirp of the laser.

The present invention overcomes the drawbacks of prior art methods by changing the absorption coefficient in at least a part of the rear reflector of the laser to cause its reflectivity to be modulated. The structure of the laser and its rear reflector is designed such that the reflectivity phase has no or little variation when the reflectivity is changed, thus resulting in a very low wavelength chirp. No wavelength sensitive resonant cavity is involved in the modulation mechanism. The optical loss variation can be achieved by current injection using the same material as the laser gain medium, thus greatly simplifying the fabrication. The details of the monolithic Q-modulated semiconductor laser structures that implement the above mechanism are disclosed below.

FIG. 3 shows a single-mode semiconductor laser monolithically integrated with an electro-absorptive Q-modulator in accordance with one embodiment of the present invention. The laser comprises a λ/4-phase-shifted DFB grating 130, divided into a gain section and a modulator section. The gain section provides an optical gain for the laser when a constant current is injected through an electrode 108. It consists of the phase-shift region 100, and sections 101 and 102 on the opposite sides of the phase-shift region. The modulator section 105 comprises a grating segment away from the phase-shift region, which acts as a Q-modulator of the laser. An electrical signal is applied on the modulator section through the electrode 110 to change the absorption coefficient of the underlying waveguide, resulting in a change in the Q-factor of the laser, and consequently the lasing threshold and output power. The laser beam 140 emits from the end facet of the gain section on the opposite side of the modulator.

The waveguide structure generally consists of a buffer layer 116, a waveguide core layer 114 that provides an optical gain when electrically pumped, and an upper cladding layer 112, deposited on a substrate 118. Preferably the waveguide core layer 114 comprises multiple quantum wells and the layers are appropriately doped as in conventional laser structures. In the transverse direction, standard ridge or rib waveguides are formed to laterally confine the optical mode. Two electrically isolated electrodes 108 and 110 are deposited on the top surface in the laser and modulator sections, respectively. The backside of the substrate is also deposited with another metal electrode layer 120 as a common ground plane. The electrode pair 108/120 provides a means for injecting current to produce an optical gain in the active laser section. In the modulator section, the electrode pair 110/120 is used to apply an electrical means (either a current injection or a reverse biased voltage) to change the absorption coefficient of the waveguide and consequently to change the Q-factor of the laser.

The waveguide materials for the gain and modulator sections can be different so that the structure can be optimized for each individual section of a different functionality. This can be done by using the etch-and-regrowth technique or a post-growth bandgap engineering method such as quantum well intermixing. A simpler method is to use the same laser structure with different operating voltage/current levels to obtain different properties for the two different sections. For example, while the gain section is strongly pumped to generate optical gain, the modulator section varies between the transparent state (small current injection) and absorptive state (zero current injection).

To illustrate the operating principle of the Q-modulated laser, we consider a numerical example where the grating has a rectangular effective index profile with n₁=3.215, and n₂=3.21 (Δn=0.005) and a period Λ=0.2412 μm. The operating wavelength is at λ=1550 nm. The modulator section has a length Lₘ=150 μm. The gain section has a total length of 400 μm, with a λ/4 phase shift located 100 μm away from the modulator (i.e. the lengths of the sections 101 and 102 are L₁=300 μm, and L₂=100 μm, respectively).

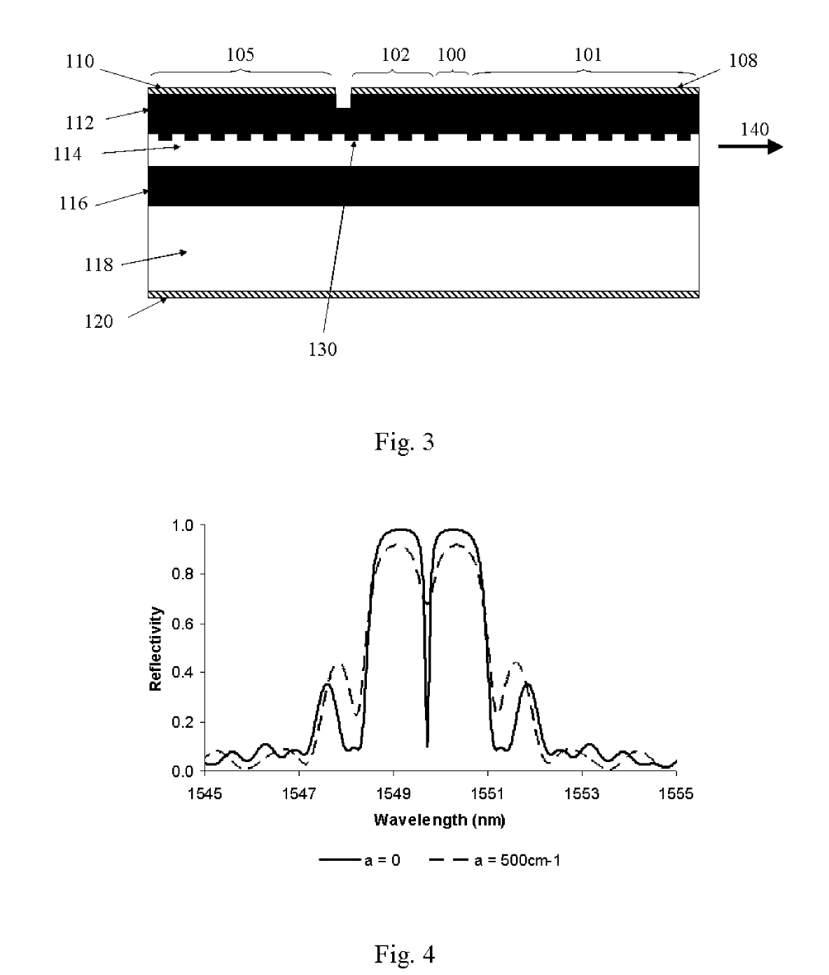

The Q-factor of a laser cavity can be described by Q=λ/Δλ, where Δλ is the linewidth of its resonant peak in its transmission or reflection spectrum when the gain section is transparent. FIG. 4 shows two reflectivity spectra of the cavity for light incident from the gain section side, when the modulator is set to the transparent (on) and absorptive (off) states. In this example, the absorption coefficient of the modulator section is assumed to be α=0, and α=500 cm⁻¹, for the on and off states, respectively. The full width at half maximum of the negative reflectivity peak is 0.1 nm and 0.37 nm for the two states, corresponding to a Q-factor of 15500 and 4189, respectively.

The phase shifted DFB grating can also be considered as a Fabry-Perot cavity with two reflecting mirrors consisting of the two distributed Bragg reflector (DBR) gratings. The first DBR is the segment 101 on the right side of the phase-shift. The second DBR comprises the modulator section 105 and the grating segment 102 on the left side of the phase shift region. The lasing wavelength is determined by the following resonance condition

$$\frac{4 π n}{λ} ( {L}_{p} + \frac{⩓}{2} ) + {Φ}_{1} + {Φ}_{2} = 2 m π \qquad ( 1 )$$

where n is the average effective index in the phase-shift region, Λ=λ/2n is the grating period, Lₚ the phase-shift amount (i.e. the length of segment 100 is Lₚ+Λ/2), Φ₁ and Φ₂ are the reflection phase changes of the first and the second DBRs as seen from the phase shift region, and m is an integer. It is well-known that a DBR grating has a wavelength window called “stop band” for which most of the incident light is reflected. For the wavelength in the middle of the DBR stop band, we have Φ₁=Φ₂=0. For m=1, we obtain Lₚ=λ/4n, which corresponds to a quarter-wavelength phase shift. Such a quarter-wavelength phase-shifted DFB structure can be realized by inverting the grating pattern on one side of the phase shift position with respect to the other, using photoresists of opposite polarities (i.e. positive and negative) during the grating patterning process.

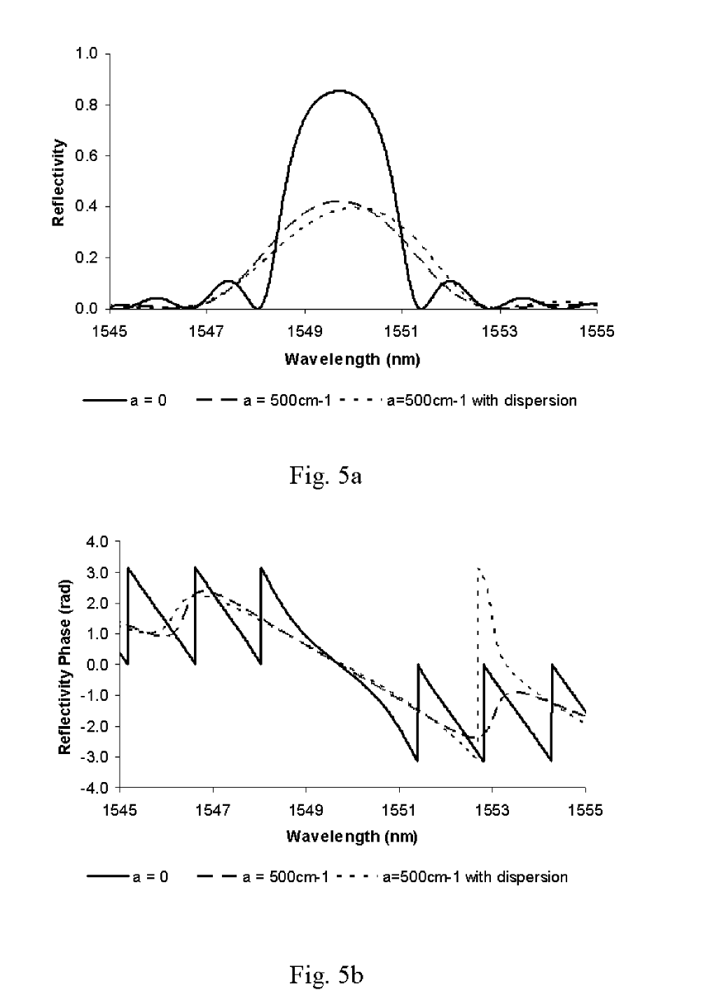

FIG. 5 shows the reflectivity spectra (a) and the corresponding reflection phase change (b) of the second DBR grating (i.e. the combined sections of 102 and 105 with the light incident from the phase shift section 100) when the absorption coefficient of the modulator section 105 is α=0, and α=500 cm⁻¹. We can see that the peak reflectivity changes significantly with the modulator absorption, while the associated phase change is minimal at the peak wavelength (i.e. middle of the stop band). This reflectivity change results in a change in the Q-factor of the laser cavity, and consequently the lasing threshold. The minimal phase change is important for minimizing the wavelength chirp of laser, as is evidenced by Eq. (1).

In semiconductor materials, the absorption change is accompanied by a refractive index change through Kramer-Kronig relationship, which may be significant under certain operating regimes. This refractive index change can be used to enhance the laser threshold modulation. However, the refractive index change will produce a peak shift as well as a phase change in the reflectivity, resulting in an increased wavelength chirp. By including a DBR grating segment 102 (L₂=100 μm in our example) between the modulator and the phase-shift region, such peak shift and phase change are minimized. FIG. 5 also shows the reflectivity spectrum and phase change of the DBR grating for the absorptive modulator state when the absorption increase is accompanied by a refractive index increase of 0.005 in the modulator section. The refractive index change results in a reflectivity peak shift of only about 0.35 nm.

In the absence of the DBR segment 102, the reflectivity peak shift of the modulator section is determined by

$$Δ λ = \frac{Δ n}{n} λ \qquad ( 2 )$$

This leads to a wavelength shift of Δλ=1550×0.005/3.215=2.4 nm in our example. Therefore, by including a DBR segment 102 between the modulator and the phase shift region, the wavelength shift is greatly reduced. From FIG. 5(b), one can see that the phase change is also insignificant in the central region of the stop band. For a given refractive index change, the peak shift and phase change increase with decreasing L₂. On the other hand, the modulation efficiency decreases with increasing L₂. Therefore, there is a trade-off when choosing the length L₂ of segment 102, which depends on the refractive index step of the grating.

Compared with a directly modulated laser comprising a phase-shifted DFB laser, the advantage of the Q-modulated laser of the present invention in terms of wavelength chirp reduction is apparent from Eqs. (1) and (2). In the case of the directly modulated laser, since the refractive index of the whole laser structure changes with the modulation current, the resulting wavelength variation is determined by Eq. (2), which is about 2.4 nm in the above example. By modulating the loss in only a portion of the grating away from the phase-shift region, the refractive index n of the phase shift region and the phase Φ₁ of the first DBR in Eq. (1) become constant. Only the phase Φ₂ of the second DBR varies slightly with the modulation current, and this phase variation is minimized by having segment 102 of a certain length between the modulator section and the phase-shift region, as shown in FIG. 5(b). Therefore, the wavelength chirp is greatly reduced.

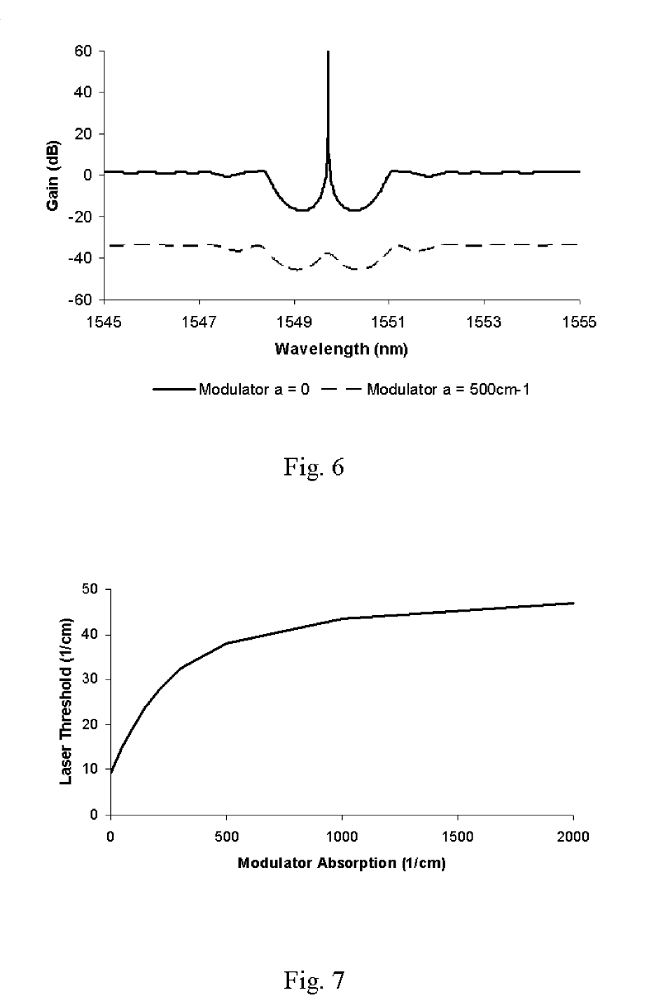

FIG. 6 shows the small signal gain spectra of the example laser structure, calculated at a gain coefficient of g=9.25 cm⁻¹ for modulator absorption coefficient α=0, and α=500 cm⁻¹. Due to the quarter-wavelength phase shift in the DFB grating, the lasing wavelength occurs in the middle of the stop band. When the modulator is at the transparent state (α=0), the threshold gain coefficient of the lasing mode is 9.25 cm⁻¹. When the modulator is at the absorptive state with α=500 cm⁻¹, the threshold gain coefficients of the lasing mode is increased to 38 cm⁻¹, while their lasing wavelengths remain the same at λ=1549.711 nm. When the refractive index change is taken into account in the calculation, the threshold gain becomes 41.5 cm⁻¹ and the lasing wavelength is at 1549.745 nm, a shift of only 0.034 nm. This compares to a wavelength chirp in the order of several nanometers in a conventional directly modulated DFB laser, a reduction of almost two orders of magnitude. The large threshold difference between the two modulator states for the lasing mode reflects the effective Q-switching caused by the loss variation in the modulator. When the gain section is pumped by a constant current producing an optical gain that is below the threshold for the absorptive modulator state but well above the threshold for the transparent (or low absorption/gain) state, the laser output will be modulated by the signal applied on the modulator. The negligible phase change associated with the Q-modulation resulting in a low wavelength chirp is a significant advantage of the device of the present invention.

FIG. 7 shows the laser threshold gain coefficient as a function of the modulator absorption. We can see that a threshold difference of about 300% can be obtained with a modulator absorption coefficient of only 200 cm⁻¹.

In the above embodiment, the effective index of the modulator section in the on-state is ideally the same as that of the gain section. During the operation of the device, the gain section is pumped at a relatively high current in order to provide optical gain to the laser. The modulator section may be injected with about the same level of current density in the on-state especially if the waveguide material, the cross-sectional structure and the grating pitch are the same between the gain and modulator sections. However, the modulator section is not necessary to be pumped at such a high current level even for the on-state. A high current injection on the modulator would lead to an increased driving power requirement. An injection current that makes the waveguide substantially transparent is normally sufficient for the on-state. Due to the difference between the injection current densities in the gain section and the modulator section, the effective index of the modulator section becomes slightly different than that of the gain section. Although this effect is not significant, it may be compensated by adjusting the lateral geometrical structure of the channel waveguide (e.g. the ridge waveguide width) in the modulator section. A waveguide taper may be used between the sections to reduce transitional loss.

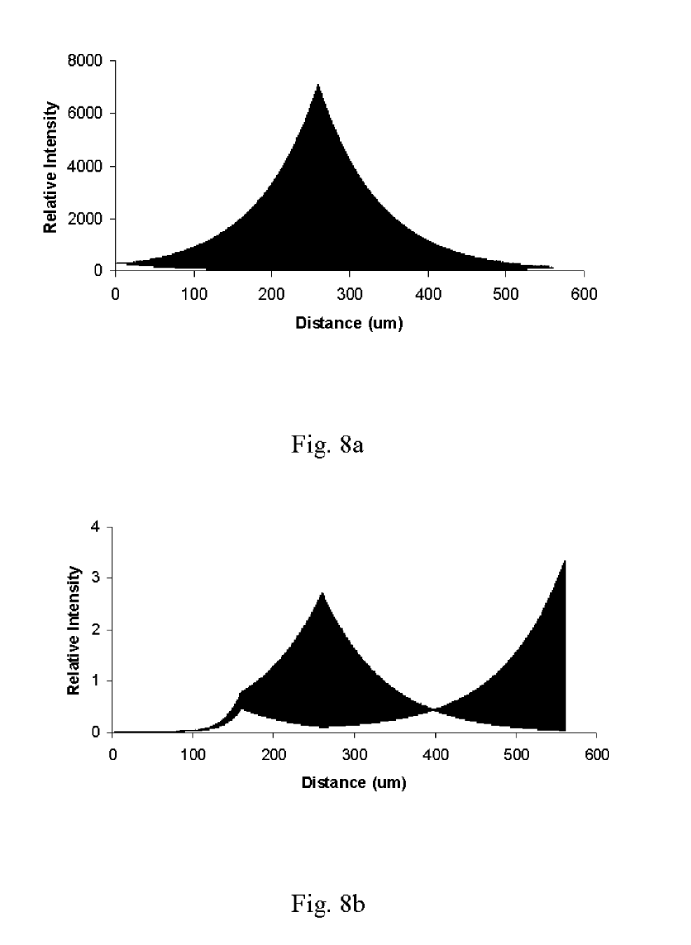

FIG. 8 shows the intensity distribution inside the laser structure when the modulator is in the on-state (a) and off-state (b), calculated for modulator absorption coefficient of α=0, and α=500 cm⁻¹, respectively, and with a gain coefficient of g=8.8 cm⁻¹. We can see that in the on-state, the intensity increases exponentially from both ends and reaches the maximum at the phase-shift position. When the modulator is switched to the absorptive off-state, the intensity decreases drastically and changes the distribution profile. The extremely uneven field distribution, especially the sharp peak around the phase-shift region will cause strong spacial hole burning effect and severe gain saturation when the laser is in the on-state.

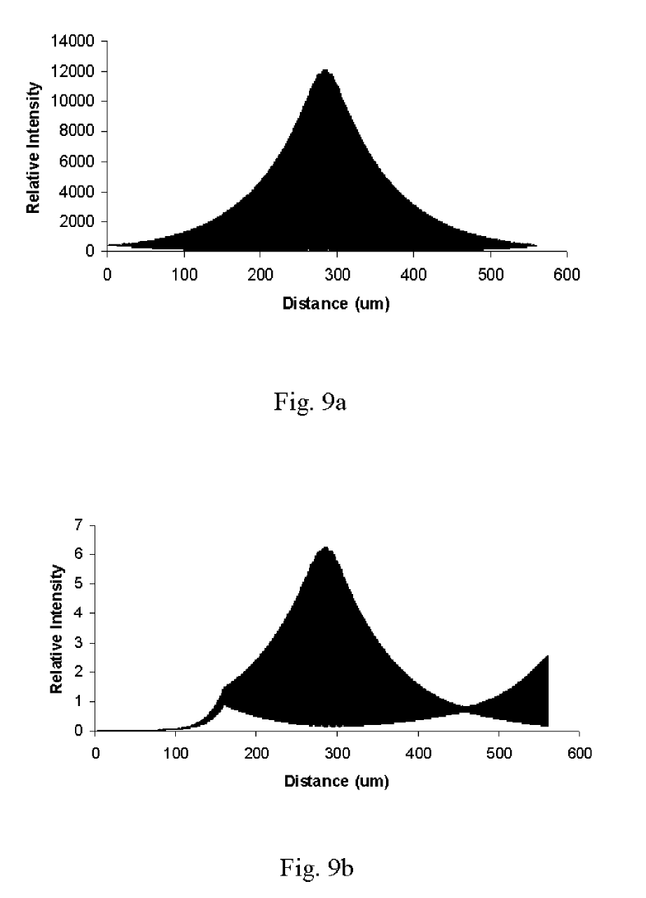

To mitigate the spacial hole burning effect, the phase shift may be implemented through a waveguide section of a certain length with a slightly different effective index. We consider another numerical example where the modulator section has a length Lₘ=150 μm, and the gain section consists of two DBR sections of L₁=250 μm and L₂=100 μm separated by a phase-shift section of a length Lₚ=50 μm. The phase section has the same grating pitch of Λ=0.2412 μm but its average effective index is reduced to 3.204 as compared to 3.2125 in all other sections. FIGS. 9(a) and (b) depict the intensity distributions in the modulator on-state (α=0) and off-state, respectively, calculated for a gain coefficient of g=8.2 cm⁻¹. Compared to FIG. 8, the intensity variation in the phase-shift region becomes less drastic. The lasing threshold is 8.6 cm⁻¹ for the modulator on-state and 29 cm⁻¹ for the modulator off-state (α=500 cm⁻¹), with the lasing wavelength at λ=1549.75 nm. The phase-shift section of the DFB grating in this example can be implemented by using a different ridge width, or by using a separate electrode with a different injected current density.

The Q-modulation mechanism of the present invention can also be implemented in conventional DFB lasers with a uniform grating (i.e. without phase shift region). However, in this case, the DBR grating in the modulator section needs to have a detuned stop-band with respect to the DFB section. In order to obtain high single-mode yield, a partially gain coupled DFB grating can be used, similar to the one described by G. P. Li, T. Makino, and H. Lu in an article entitled “Simulation and interpretation of longitudinal-mode behavior in partly gain-coupled InGaAsP/InP multiquantum-well DFB lasers”, IEEE Photonics Technology Letters, vol. 4, no. 4, pp. 386˜388, 1 993. In this case, the lasing wavelength occurs at the long wavelength side of the stop band of the DFB. In accordance with the present invention, the modulator section of the grating is operated at the high reflectivity mode which is substantially in the middle of its stop band. This is important because the phase change between the on and off states is minimal for a wavelength in the central region of the stop band, as can be seen in FIG. 5(b). Therefore, a wavelength detuning is necessary between the DBR modulator section and the DFB gain section in order to reduce the wavelength chirp. Again, this wavelength detuning can be achieved by adjusting the cross-sectional waveguide structure such as the ridge waveguide width or the grating pitch. Alternatively, a fixed or adjustable phase section can be added between the DFB section and the modulator section so that the laser wavelength is adjusted to the middle of the stop band of the DBR grating in the modulator section. To reduce the phase change and the wavelength shift caused by the refractive index change accompanied with loss modulation, another DBR grating section with a fixed injection current may be inserted between the modulator and the phase/DFB section. The fixed current DBR section may be combined with the phase/DFB section to form the gain section with a common electrode, similar to the preferred embodiment of FIG. 3.

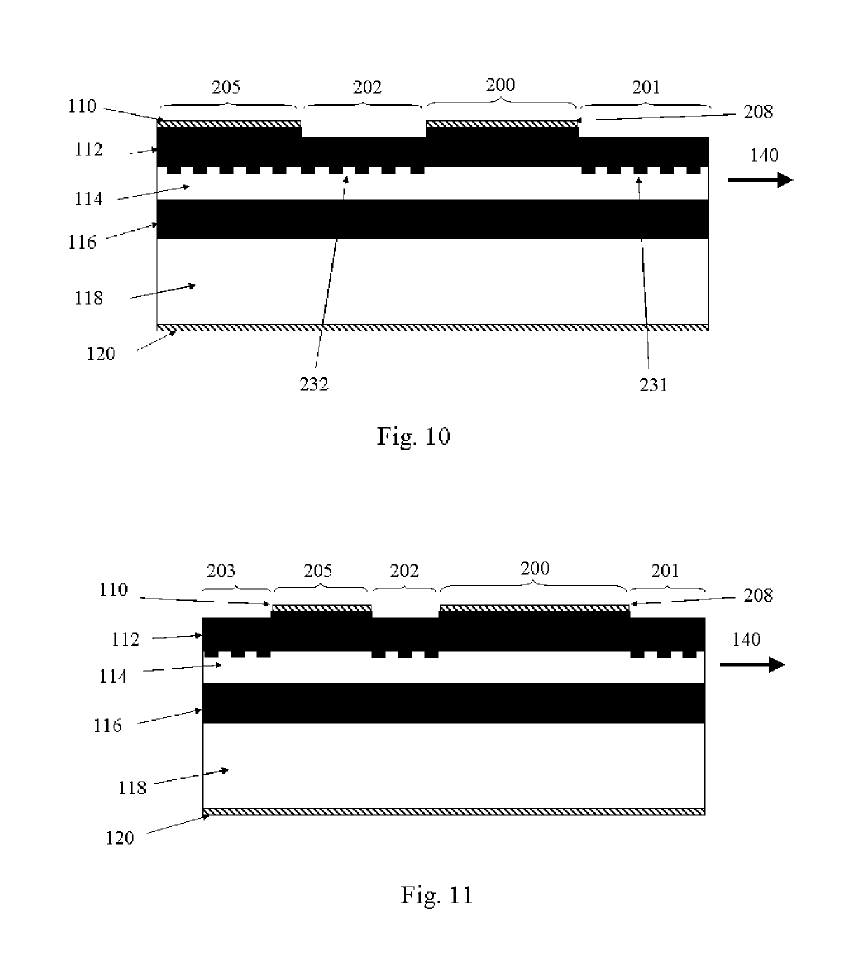

The integrated Q-modulated semiconductor laser can also be implemented in the form of a distributed Bragg reflector (DBR) laser. FIG. 10 shows another embodiment of the present invention. The laser comprises a gain waveguide section 200 placed between two DBR gratings 231 and 232. The waveguide section 201 comprising the DBR grating 231 and the waveguide section 202 comprising a portion of the DBR grating 232 are passive and substantially transparent. The gain section does not contain grating corrugations and is sandwiched between a pair of electrodes 208/120 for injecting current to provide optical gain to the laser. The modulator section 205 of the DBR grating 232 is also sandwiched between a pair of electrodes 110/120 for providing an electrical means to change the optical loss of underlying optical waveguide so that the change of the optical loss causes a change in the Q-factor of the laser, and consequently the lasing threshold and output power.

FIG. 111 depicts another embodiment of the invention where the waveguide of the modulator section 205, without grating corrugations in its own layer structure, is placed between two DBR grating sections 202 and 203. This appears to form a second Fabry-Perot cavity for the modulator in addition to the cavity for the gain section. However, this modulator cavity is substantially operated in the anti-resonant condition, i.e.,

$$\frac{4 π n}{λ} {L}_{m} + {φ}_{1} + {φ}_{2} = 2 ( m + 1 ) π \qquad ( 3 )$$

where Lₘ is the length of the active modulator section 205, φ₁ and φ₂ are the reflection phase changes of the DBR grating sections 202 and 203, respectively, as seen from the modulator section, and m is an integer. This is in contrast to the resonant condition for the gain cavity, that is,

$$\frac{4 π n}{λ} L + {Φ}_{1} + {Φ}_{2} = 2 m π \qquad ( 4 )$$

where L is the length of the gain waveguide 200, Φ₁ and Φ₂ are the reflection phase changes of the DBR gratings 201 and 202, respectively, as seen from the gain section 200. The change of optical loss in the modulator waveguide section 205 results in a change in the Q-factor of the gain cavity, and consequently the lasing threshold and the output power.

It is obvious to one skilled in the art that the DBR grating 201 in the embodiments of FIG. 10 and FIG. 11 can be replaced by a partially reflecting cleaved facet with or without a dielectric thin-film coating.

The advantages of the devices of the present invention are numerous. Due to the fact that the modulation is done separately from the active gain section, the latter is pumped by a constant current. This not only reduces the wavelength chirp, but also increases the modulation speed due to a much shorter length, and consequently a much smaller capacitance of the modulator compared to the active gain section or to an external electro-absorption modulator. Compared to an electro-absorption modulator placed in the path of the output laser beam, the extinction ratio of the present device is much higher due to its Q-switching mechanism, without needing a long modulator length. In addition, it does not cause an inherent power loss of 3 dB as in the case of an external electro-absorptive modulator.

Numerous other embodiments can be envisaged without departing from the spirit and scope of the present invention. For example, the principle of the Q-modulated semiconductor laser of the present invention can also be implemented in the configuration of vertical cavity surface emitting lasers (VCSEL).

What is claimed is:

1. A Q-modulated semiconductor laser comprising:
a phase-shifted grating embedded in an active optical waveguide layer structure,
a first waveguide section with a first segment of the grating embedded therein, and a second waveguide section with a second segment of the grating embedded therein, said first and second segments of the grating being on opposite sides of the phase-shift region,
a third waveguide section with a third segment of the grating embedded therein, said third waveguide section being adjacent to the second waveguide section,
a first electrode deposited on top of the first and the second waveguide sections, said first electrode being used for injecting a constant current into underlying active optical waveguide to provide optical gain to the laser,
a second electrode deposited on top of the third waveguide section, said second electrode being used for providing an electrical signal to change the optical loss of underlying optical waveguide so that the change of the optical loss causes a change in the output power of the laser.

2. A Q-modulated semiconductor laser as defined in claim 1, wherein the amount of the phase shift in the grating is substantially equal to a quarter wavelength.

3. A Q-modulated semiconductor laser as defined in claim 1, wherein the phase shift in the grating is realized by inverting the grating pattern on one side of the phase shift position with respect to the other.

4. A Q-modulated semiconductor laser as defined in claim 1, wherein the phase shift in the grating is realized by using a fourth waveguide section of a different effective index but with the same grating pitch with respect to the other waveguide sections.

5. A Q-modulated semiconductor laser as defined in claim 4, wherein the fourth waveguide section for realizing the phase shift is implemented using a different lateral waveguide width with respect to the first and the second waveguide sections.

6. A Q-modulated semiconductor laser as defined in claim 4, wherein the fourth waveguide section for realizing the phase shift is covered by a separate third electrode for injecting a current of a different density with respect to the one injected into the first and the second waveguide sections.

7. A Q-modulated semiconductor laser as defined in claim 1, wherein the third segment of the grating embedded in the third waveguide section has a stop band substantially centered at the operating wavelength of the laser.

8. A Q-modulated semiconductor laser as defined in claim 7, wherein the second segment of the grating embedded in the second waveguide section has a stop band substantially centered at the operating wavelength of the laser.

9. A Q-modulated semiconductor laser as defined in claim 8, wherein the third waveguide section has a different lateral dimension than the second waveguide section in order to compensate for the effective index difference caused by different operating conditions between the two waveguide sections.

10. A Q-modulated semiconductor laser as defined in claim 8, wherein the second and the third segments of the grating have a different pitch than the first segment of the grating in order to align their stop band with the operating wavelength of the laser.

11. A Q-modulated semiconductor laser as defined in claim 8, wherein the second and the third waveguide sections have a different lateral dimension than the first waveguide section in order to align the stop band of the second and the third segments of the grating with the operating wavelength of the laser.

12. A Q-modulated semiconductor laser as defined in claim 1, wherein the optical loss in the third waveguide section is changed by current injection.

13. A Q-modulated semiconductor laser as defined in claim 1, wherein the optical loss in the third waveguide section is changed by electro-absorption effect through a reverse biased voltage.

14. A Q-modulated semiconductor laser comprising:
a first distributed Bragg reflector grating,
a second distributed Bragg reflector grating,
a gain section placed between the first and the second distributed Bragg reflector gratings, said gain section being sandwiched between a pair of electrodes for injecting a constant current to provide optical gain to the laser,
an electrically-controllable absorption section being placed within the second distributed Bragg reflector grating, said electrically-controllable absorption section being sandwiched between a pair of electrodes for providing an electrical signal to change the optical loss of said electrically-controllable absorption section so that the change of the optical loss causes a change in the output power of the laser.

15. A Q-modulated semiconductor laser as defined in claim 14, wherein said electrically-controllable absorption section comprises a first segment of the second distributed Bragg reflector grating, said first segment being separated from the gain section of the laser by a second segment of the second distributed Bragg reflector grating.

16. A Q-modulated semiconductor laser as defined in claim 14, wherein said electrically-controllable absorption section is placed inside an anti-resonant cavity formed between two segments of the second distributed Bragg reflector grating.

17. A Q-modulated semiconductor laser as defined in claim 14, wherein the optical loss in the electrically-controllable absorption section is changed by current injection.

18. A Q-modulated semiconductor laser as defined in claim 14, wherein the optical loss in the electrically-controllable absorption section is changed by electro-absorption effect through a reverse biased voltage.
